(19) United States
(12) Patent Application Publication
(10) Pub. No.: US 2026/0127065 A1
(43) Pub. Date: May 7, 2026

(54) TECHNOLOGIES FOR PREVENTING FAULT EXCEPTION PROBING

(71) Applicant: SiFive, Inc., Santa Clara, CA (US)

(72) Inventors: John Ingalls, Mountain View, CA (US); Perrine Peresse, Tourrettes-sur-Loup (FR); Cyril Bresch, Marseille (FR)

(73) Assignee: SiFive, Inc., Santa Clara, CA (US)

(21) Appl. No.: 18/938,085

(22) Filed: Nov. 5, 2024

(51) Int. Cl. G06F 11/07; G06F 12/1045

(52) U.S. Cl. CPC G06F 11/0772; G06F 11/073; G06F 12/1063; G06F 2212/684

(57) ABSTRACT

The present application relates to devices and components, including apparatus, systems, and methods for scheduling delivery and execution of page fault or permission fault exceptions. A memory management unit may receive a virtual address associated with an execution mode and initiate a virtual-to-physical translation operation. The MMU may detect a first condition associated with a search of the virtual address in a translation lookaside buffer (TLB). In response to the detection of the first condition, MMU may start a timer. MMU may detect a fault exception associated with the translation operation of the virtual address and determine that a second condition is satisfied. In response to detecting the second condition, the MMU or the reorder buffer exception monitor may deliver the fault exception based on the timer.

### TECHNICAL FIELD

This application relates generally to processing circuitry and, in particular, to memory management unit (MMU) micro-architecture for preventing table lookaside buffer (TLB) probing.

### BACKGROUND

Side-channel attacks exploit indirect information leakage to gain unauthorized access to sensitive data. Unlike traditional attacks that target software vulnerabilities or cryptographic weaknesses, side-channel attacks focus on the physical and timing characteristics of a system. These characteristics include power consumption, electromagnetic emissions, or the time to execute certain operations. For example, an attacker might deduce secret keys or other sensitive information by carefully measuring the time it takes to execute cryptographic algorithms. This attack is particularly insidious because it often bypasses traditional security mechanisms.

One common type of side-channel attack is the cache timing attack, where an attacker exploits the differences in access times between cached and non-cached data.

Techniques like Flush+Reload and Prime+Probe are used to manipulate and observe the state of the cache. In a Flush+Reload attack, the attacker flushes a shared cache line and then measures the time it takes to reload it, inferring whether the victim accessed that line. Prime+Probe involves the attacker filling the cache with their data (priming) and then measuring which parts of the cache have been evicted by the victim's access patterns (probing). These attacks can reveal fine-grained details about the victim's operations, including cryptographic keys. Preventing side-channel attacks is desired because they threaten the confidentiality and integrity of sensitive information.

### BRIEF DESCRIPTION OF THE DRAWINGS

FIG. 1 illustrates a compute system in accordance with some embodiments.

FIG. 2 illustrates aspects of the compute system in accordance with some embodiments.

FIG. 3 illustrates a block diagram of a memory management unit in accordance with some embodiments.

FIG. 4 illustrates another block diagram of page table entry walk cache operation in accordance with some embodiments.

FIG. 5 illustrates a finite state machine of a page table walker in accordance with some embodiments.

FIG. 6 illustrates a finite state machine of a unified translation look-aside buffer operation in accordance with some embodiments.

FIG. 7 illustrates a flow diagram in accordance with some embodiments.

FIG. 8 illustrates a block diagram of an example of a multi-chip package in accordance with some embodiments

FIG. 9 illustrates a block diagram of an example of a computing system in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

When an application issues a memory access request, it initiates a series of interactions within the processing core and Memory Management Unit (MMU). The processing core first receives the virtual address (a virtual memory address) from the application and passes it to the MMU. Among other things, MMU is responsible for translating the virtual address into a physical address (physical memory address). This translation allows the processing unit to access the correct location in physical memory. The virtual address allows programs to use memory without being directly involved with the actual physical layout of the memory. The physical address is the actual address in the physical memory where the data or instructions are stored.

The MMU begins by checking the translation lookaside buffer (TLB), a specialized cache that stores recent virtual-to-physical address translations. Each entry in the TLB may include a virtual page number (VPN), a corresponding physical page number (PPN), access control bits the specify permission (such as read, write, and execute), a valid bit indicating if the entry is usable, or a tag used for quick identification in associative TLBs. The TLB may be fully associative, set-associative, or direct-mapped, which determines how flexible and quick the lookup process is. MMU may extract PPN from the virtual address and search the TLB for a matching entry. If f a match is found (a TLB hit), the corresponding PPN is retrieved, and the physical address is constructed by combining the PPN with the page offset from the virtual address. However, the MMU must perform a page table walk if the translation is not found in the TLB (a TLB miss). Page table walk may be performed by a page table walker (PTW). PTW may include hardware or software components.

During the page table walk process, the PTW traverses multiple levels of page tables to find the correct physical address. This process may involve accessing different levels of the page table hierarchy, which can vary depending on the system's design (e.g., page table root, level 1 table; translation table base register, and level 1 table; or page map level 4, page directory pointer table, page directory, or page table). Once the PTW retrieves the physical address, this translation is cached in the TLB for future use, optimizing subsequent memory accesses. The page table walker may include hardware (e.g., circuitry) and software (e.g., algorithms, codes, or firmware) within the MMU responsible for performing the page table walk process.

After obtaining the physical address, the MMU/CPU may check the cache hierarchy to locate the requested data or instructions. It starts with the L1 cache (e.g., L1 cache for data (L1D) or L1 cache for instructions (L1I)), the fastest but smallest cache level. If the data is found in the L1 cache (a cache hit), it is returned to the CPU. If a cache hit is not detected, the process moves to the L2 cache, which is a larger and slower cache than the L1 cache. If the requested data or instruction is still not found, the search proceeds to the L3 cache (if available) and, ultimately, to the main memory (e.g., random access memory (RAM)) if all cache levels miss.

In some instances, the MMU may fail to translate the virtual address into a physical address through the TLB lookup and the page table walk process. The inability or failure to translate the virtual address into a physical address may indicate that the virtual address is not currently mapped to any physical address. Failure to translate a virtual address into a physical address may occur for several reasons, such as an invalid virtual address or the corresponding page not being loaded into memory. When the MMU cannot find a valid translation for the virtual address, the MMU may generate a page fault exception. A page fault exception may indicate that the required page is not currently mapped in the physical memory and may serve as a signal to the operating system (OS) that the OS needs to handle the fault.

In some examples, memory access permissions may be implemented. Memory access permissions may include a set of rules governing how different parts of a computer system can access various regions of memory. These permissions are typically defined at the OS level and enforced by the MMU. The permissions may specify whether a particular memory region can be read, written to, or executed, and they are used to provide security and stability to the system.

In some instances, the operating system is responsible for setting memory access permissions. When a process is created, the OS allocates memory for it and assigns appropriate permissions to different memory regions, such as code, data, stack, and heap segments. The MMU may enforce the permissions set by the OS. When the processing core attempts to access memory, the MMU may check the access permissions for the target memory region. If the access violates the permissions, the MMU may generate an exception (such as a page fault or segmentation fault) to notify the OS. In some cases, user applications can request changes to memory access permissions through system calls provided by the OS. For example, an application might request to make a memory region executable to run dynamically generated code.

The MMU may enforce memory access permissions during the page table walk process. Each page table entry (PTE) may contain permission bits that specify read, write, and execute rights. The MMU may trigger a page fault or access violation exception if the application lacks the required permissions to access the memory address. The page fault handler of the operating system (OS) may determine the cause of the fault and may take appropriate action, such as loading the required page from the disk or terminating the application for illegal access.

The fault exceptions may include both hardware and software components, for example. MMU may detect fault exceptions at the hardware level, generating a signal to indicate the detection of the fault exception.

There are two types of fault exceptions described above: the first type is caused by a virtual address not being mapped to a physical address, and a lack of access permission causes the second type. In some instances, page fault exceptions of the second type occur before the completion of the page table walk process, whereas the page fault of the first type may occur at or after the completion of the page table walk process. In the context of side-channel attacks, attackers may exploit timing differences between the two types of page fault exceptions. It is beneficial to make the timing of the two types of fault substantially similar, hence preventing attackers from exploiting the timing difference between the two types of page fault exceptions.

Kernel may be referred to as a core component of an operating system that manages system resources and facilitates communication between hardware and software. It may be responsible for functions such as process management, memory management, device management, and system calls. The kernel may use kernel address space layout randomization to locate itself randomly in memory and hide its location from attackers. To circumvent this, attackers may probe pages of memory and time how long it takes to get a privilege violation (if the violation is returned quickly, it may likely be in the TLB and may indicate the kernel location). To prevent attackers from extracting information from the timing of privilege violation, the MMU may make the page fault of unused or unmapped pages to have the same timing as privilege violations protecting the kernel.

In some embodiments, the MMU may start a timer when a TLB miss or hit occurs. MMU may delay fault exceptions from user mode that result from an invalid (unmapped) PTE (page fault) or fault exceptions from kernel mode that are associated with a lack of permission (permission fault). In some instances, MMU may not delay faults due to only access, dirty, or write permission bits being clear. The fault exception may be an interrupt or an exception.

The Reorder Buffer (ROB) exception monitor may handle exceptions or faults during instruction execution, such as page faults and permission errors. In some embodiments, the fault exception may be added to the ROB exception monitor. When the fault exception is the oldest in the ROB exception monitor and it is its turn to be released or executed, the ROB exception monitor may delay its delivery until the timer expires. In some instances, the timer may expire before the exception reaches the oldest in the ROB exception monitor. An interrupt associated with the expiration of the timer may preempt the ROB exception monitor.

In some instances, the timer may be based on a wall-clock timer, e.g., microseconds. For example, a global high-resolution timer (GHRT) may be used. Alternatively, the timer may be based on counting cycles. In some embodiments, the value of the timer may be programmable and stored in a control and status (CSR) register. In some embodiments, random noise may be added to the value of the timer. In some embodiments, the value of the timer is randomly selected from a range. The value of the timer may be dynamically updated.

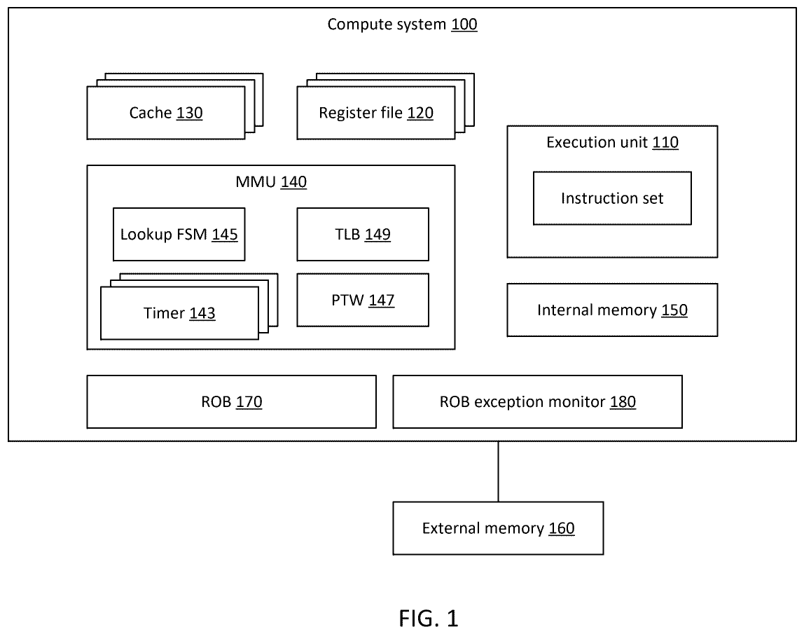

FIG. 1 illustrates a compute system 100 in accordance with some embodiments. Compute System 100 may include a combination of hardware and software designed to perform computational tasks. Compute system 100 may be a central processing unit (CPU) with one or more cores, maybe a core within a CPU, a special-purpose computer designed for a specific task (e.g., an accelerator or digital signal processing (DSP)), or a graphics processing unit (GPU) with one or more cores.

Compute system 100 may include an execution unit 110. Execution unit 110 may perform operations specified by the instructions, such as arithmetic calculations, logical operations, and data manipulation tasks. The instruction set may be a collection of instructions that compute system 100 can execute. The instruction set may determine how data is processed, manipulated, and transferred within the system. The instruction set architecture (ISA) may define the operations, data types, registers, addressing modes, and memory architecture that the execution unit can utilize.

Compute system 100 may be a complex instruction set computing (CISC) system. CISC architectures (e.g., instructions used in traditional x86 processors) may be designed to execute complex instructions that can perform multiple operations. Each instruction in a CISC architecture may execute several low-level operations, such as memory access, arithmetic operations, and branching, in a single instruction cycle. The complex instructions may reduce the number of instructions per program but may increase execution time.

Compute system 100 may be a reduced instruction set (RISC) system. RISC architectures, e.g., such as those used in ARM processors, may focus on a smaller set of simple instructions. Each instruction may be designed to execute in a single clock cycle, which can lead to faster and simpler (compared to CISC instructions) execution. RISC architectures may emphasize high performance and energy efficiency, making them suitable for mobile and embedded systems.

Compute system 100 may be a very long instruction word (VLIW) system. VLIW architectures may bundle multiple operations into a single long instruction word, allowing execution unit 110 to execute multiple operations in parallel.

Compute system 100 may be a single instruction, multiple data (SIMD) system. SIMD architectures may be used in GPUs, allowing a single instruction to operate on multiple data points simultaneously. The parallel operation on multiple data points may be beneficial in operations such as graphics rendering or tasks where the same operation is applied to larger datasets.

Execution unit 110 may include an arithmetic logic unit (ALU), floating point unit (FPU), integer unit, load/store unit, or a branch unit. The ALU may perform arithmetic operations such as addition, subtraction, multiplication, or division. ALU may also perform logical operations such as AND, OR, NOT, and XOR. The FPU may be specialized to perform floating-point arithmetic operations. Similarly, integer unit may handle integer arithmetic and logical operations. The load/store unit may manage data transfer between the execution unit 110 and the memory hierarchy, e.g., register files 120, cache 130, internal memory 150, or external memory 160. Load/store unit may handle fetching data from registers and storing data from registers back into memory (e.g., internal memory 150 or external memory 160). The branch unit may process branch instruction, altering the flow of execution based on conditions. The branch unit may evaluate conditions and determine the next instruction to execute.

Compute system 100 may include one or more register files, e.g., register file 120. Register files, e.g., register file 120, may store data such as integers, floating-point numbers, addresses, or control information. Each register in the file is identified by a unique address or index, allowing compute system 100 to read from or write to specific registers as needed.

Register file 120 may be a general purpose register (GPR). GPRs may be used for tasks such as arithmetic operations, logical operations, or data movement. GPRs can store any type of data used by compute system 100. In one example, in an x86 architecture, registers like EAX, EBX, ECX, and EDX are examples of general-purpose registers.

Register file 120 may be a floating-point register (FPR). FPRs may be used to hold floating-point numbers and perform floating-point arithmetic operations. FPRs may be used by applications associated with high precision and complex mathematical calculations, such as scientific computing and graphics rendering.

Register file 120 may be a special-purpose register (SPR). In one example, an SPR may be an instruction pointer used to keep track of the address of an instruction, e.g., the next instruction to be executed. In one example, an SPR may be a status register holding flags representing the state of the compute system 100, such as the Zero Flag or Carry Flag, used in conditional operations and branching.

Register file 120 may be a vector register. Vector registers may hold multiple values, enabling the parallel processing of data. In one example, vector registers are used by multimedia applications.

Register file 120 may be a control and status register. Control and status registers may store control and status information governing the operation of the compute system 110. For example, control and status registers may include program status words, control flags, or configuration settings.

Compute system 110 may include one or more caches, e.g., cache 130. Cache 130 may be a level 1 (L1) cache. L1 cache 130 may be designed to store frequently accessed data and instructions to speed up the execution of programs by reducing the time needed to fetch data or instructions from the external memory 160. L1 cache 130 may be an instruction cache (L1I) or data cache (L1D). Instruction cache may store instructions that compute system 100 is likely to execute. During running a program, compute system 100 may fetch instructions from the L1instruction cache. L1 data cache may store data that compute system 100 needs to access, e.g., operands from arithmetic and logic operations, intermediate results, or data that compute system 100 frequently reads or writes. In one example, Cache 130 may be a level 2 (L2) or a level 3 (L3) cache.

Compute system 100 may be communicatively coupled with internal memory 150 or external memory 160. Internal memory 150 may be an embedded memory or an on-die memory, such as high-bandwidth memory (HBM). External memory 160 may be a volatile or non-volatile memory used to store data or instructions. In one example, the volatile memory may be a random access memory (RAM). RAM may be based on dynamic RAM (DRAM) technology or static RAM (SRAM) technology. External memory 160 may be a persistent storage such as a hard disk drive (HDD) or a solid-state drive (SSD).

Compute system 100 may include MMU 140. MMU 140 may apply and enforce memory protection by implementing access control policies that prevent unauthorized access to memory. Access control may safeguard the system from errors and malicious activities. MMU 140 may use access rights based on the privilege level of the process (user mode or kernel mode). In some instances, MMU 140 may provide virtual memory management through paging and segmentation, allowing the use of memory larger than the actual physical memory by facilitating processes such as swapping, where parts of memory are moved to storage (e.g., hard disk) when physical memory is full. MMU 140 may provide multitasking by quickly switching page tables during context switching, allowing each process to have its own virtual address space

In some embodiments, MMU 140 may translate virtual addresses (also called logical addresses) generated by programs into physical addresses in the computer's memory (e.g., internal memory 150 or external memory 160). MMU 140 may be embedded in a processing unit (e.g., a central processing unit (CPU) or a graphics processing unit (GPU)) or, a multi chip package (MCP), or a system on chip (SoC). In some instances, MMU 140 may be a stand-alone component or external to the processing unit, MCP, or SoC.

MMU 140 may include a translation lookaside buffer (TLB) 149 and a lookup finite state machine (FSM) 145. TLB 149 may be a cache that stores recent translations of virtual addresses to physical addresses. TLB 149 may include several cache hierarchy, e.g., L1 TLB or L2 TLB. TLB 149 may be dedicated for translating virtual instruction addresses, e.g., L1 ITLB or L2 ITLB, or dedicated for translating virtual data addresses, e.g., L1 DTLB, or L2 DTLB.

TLB 149 might be a unified TLB (UTLB) used for translating both instruction and data virtual addresses. TLB 149 may be used to speed up the address translation process by reducing the need to access the main page tables frequently. When the compute system 100 generates a virtual address, MMU 140 may first check the TLB 149 to determine whether the translation is already present. If the translation exists, the TLB 149 may return the physical address. If the translation is not in the TLB 149, lookup FSM 145 may perform a lookup operation in the page tables.

In some embodiments, MMU 140 may include a page table walker (PTW) 147. PTW 147 may be responsible for translating virtual addresses to physical addresses by walking through the page tables. In some instances, page tables may reside in memory (e.g., internal memory 150 or external memory 160). PTW 147 may include a hardware state machine that may generate memory requests to fetch page table entries (PTEs) until a leaf PTE associated with the physical address has been found or a page fault condition is encountered.

In some embodiments, MMU 140 may generate a fault exception when the entity (e.g., the process) generating the virtual address does not have access permission to the corresponding physical address. In some embodiments, MMU 140 may include a timer 143. Timer 143 may be associated with translating a virtual address to a physical address. Timer 143 may be used to schedule delivery of the fault exception associated with the lack of permission.

In some embodiments, MMU 140 may generate a fault exception when the virtual address cannot be mapped to a physical address. In some embodiments, MMU 140 may use timer 143 to schedule delivery of the fault exception associated with a virtual address not being mapped to a physical address.

In some embodiments, MMU 140 may include more than one timer, similar to timer 143. Each timer may be associated with an operation of translating a virtual address to a physical address. In some instances, more than one timer may be associated with a translation operation.

Compute system 100 may include ROB 170. ROB 170 may allow instructions to be executed out of order. For example, ROB 170 may allow instructions to be executed as soon as their operands are ready rather than strictly following the original program order. ROB 170 may track instructions that have been issued but not yet retired (completed), ensuring that they are eventually committed in the correct program order. Each entry in the ROB may correspond to an instruction and may hold information, such as the instruction's original program order, its destination register, and the execution result. ROB 170 may be used in speculative execution, where it holds the results of speculative instructions until their validity can be confirmed. If a branch prediction is incorrect, ROB 170 can discard the speculative results and restore the correct state, thus supporting robust error recovery. Additionally, ROB 170 is used for precise exception handling; when a fault occurs, such as a page fault or a permission error, ROB 170 may retain the state of the faulting instruction and subsequent instructions, allowing compute system 100 to pause and handle the fault without losing execution context.

Compute system 100 may include ROB exception monitor 180. ROB exception monitor 180 is a specialized component of compute system 100 out-of-order execution framework designed to detect, manage, and handle exceptions or faults that occur during instruction execution. These exceptions can include page faults, permission errors, arithmetic exceptions, and other runtime errors. ROB exception monitor 180 may continuously monitor the status of instructions in ROB 170, ensuring that any detected faults are promptly addressed. When an exception is detected, the monitor retains the state of the faulting instruction and subsequent instructions, allowing compute system 100 to pause execution and handle the fault without losing the execution context. ROB exception monitor 180 may trigger the appropriate exception handling routines, which might involve invoking the operating system's exception handler or specific processing unit routines designed to address the fault. ROB exception monitor 180 may enable compute system 100 to roll back to a known state before the exception occurred, discarding or rolling back speculative instructions and results executed after the faulting instruction. This mechanism may pause the commitment of instructions upon fault detection to prevent the premature commitment of instructions following the faulting instruction. After the exception is resolved, ROB exception monitor 180 may facilitate the resumption of instruction commitment in the correct program order, providing program state consistency.

In some embodiments, the fault exception may be added to the ROB exception monitor 180. When the fault exception is the oldest in the ROB exception monitor 180, and it is its turn to be released or executed, the ROB exception monitor 180 may delay its delivery or handling until the timer expires. In some instances, the timer may expire before the fault exception reaches the oldest in the ROB exception monitor 180. An interrupt associated with the expiration of the timer may preempt the ROB exception monitor 180.

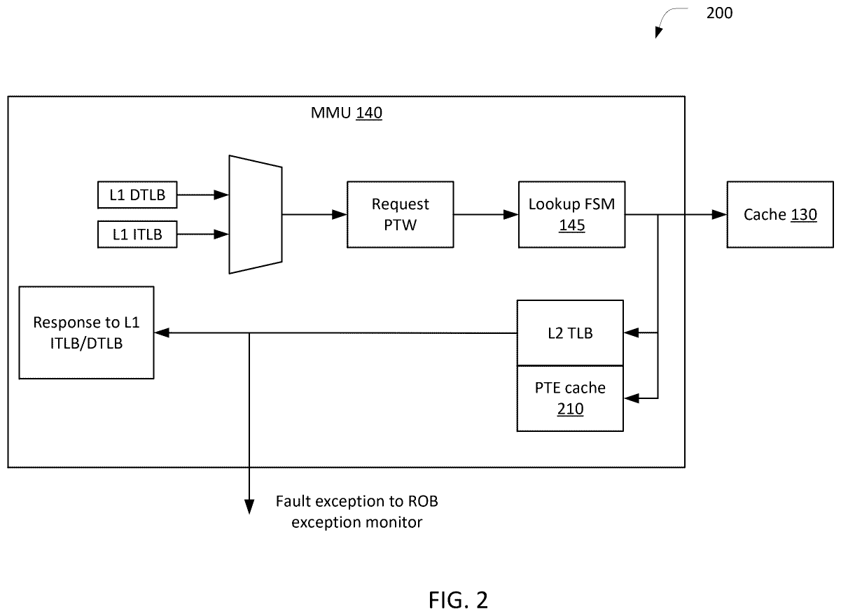

FIG. 2 illustrates a block diagram 200 of MMU 140. MMU 140 may receive a virtual address to be translated into a physical address. A program or process may generate the virtual address. The virtual address may be associated with an instruction or data. MMU 140 may check the L1 data table lookaside buffer (L1 DTLB) if the virtual address is associated with data or check an L1 instruction table lookaside buffer (L1 ITLB) if the virtual address is associated with an instruction.

The TLB 149 (e.g., L1 DTLB or L1 ITLB, or L2 TLB) may be a specialized cache used by MMU 140 to perform virtual-to-physical address translation. When compute system 100 requests a memory access, MMU 140 may first check TLB 149 (e.g., L1 DTLB or L1 ITLB, or L2 TLB). By keeping the most frequently accessed translations in a fast memory cache, the TLBs may reduce the time needed to translate addresses. If a translation is found in TLB 149, it is referred to as a TLB hit. If the translation is not in TLB 149, it is referred to as a TLB miss.

If the translation is not in the TLB (e.g., a TLB miss), MMU 140 may perform a page table lookup. MMU 140 may generate a request for page table lookup and send it to PTW 147. Lookup FSM 145 may control the page table lookup operation.

Lookup FSM 145 may first check the TLB 149. TLB 149 may be a level 2 (L2) cache. L2 TLB may be an intermediate cache between the L1 TLBs (e.g., L1 DTLB or L1 ITLB) and the main page table in memory. L2 TLB may have a larger capacity than the L1 TLBs, storing more translations. Accessing and checking L2 TLB may be faster than accessing the main page tables. In some instances, if the translation is found in L2 TLB, it may be promoted to the appropriate L1 TLB (e.g., L1 DTLB or L1 ITLB).

Lookup FSM 145 may issue memory requests to fetch page table entries (PTEs) and store them in PTE cache 210. Each PTE may include a physical page number (PPN), which maps to a specific page frame in physical memory, a present or valid bit indicating whether the PTE is currently valid and in memory, access control bits for permissions like read, write, and execute, a dirty bit to indicate if the page has been modified, or an accessed bit to show if the page has been read or written to. Additional flags may include cache control bits and privilege level bits. The translation process using PTEs may involve breaking down the virtual address into multiple parts: the page directory index, page table index, and page offset. MMU 140 may use the page directory index to locate the relevant entry in the page directory, which points to the base address of the page table. It then may use the page table index to access the corresponding entry in the page table, which provides the physical page number. The page offset may be combined with the PPN to form the complete physical address. In some instances, multi-level page tables may be used or implemented, where each level narrows down the search for the final PTE.

The translation process either determines a physical address or generates a fault exception. MMU 140 generates a response to the translation to be sent to the requesting entity, e.g., the program or process. MMU 140 may generate two types of faults during address translation: when the translation is unsuccessful and when the translation is successful but the entity generating the virtual address does not have permission. When the translation is unsuccessful, this situation is known as a page fault. A page fault occurs when MMU 140 cannot find a valid translation for the virtual address in the TLBs or page tables. A page fault may indicate that the page is not currently loaded into physical memory or the page table entry (PTE) is marked as invalid. The handling of a page fault can differ based on the execution mode. For example, when execution mode is in user mode, the operating system (OS) intervenes to resolve the fault by suspending the offending process and triggering a page fault handler. If the page is not present in physical memory, the handler locates the page in secondary storage, loads it into physical memory, updates the PTE with the new physical address, and marks the entry as valid before resuming the process. If the PTE is invalid for other reasons, the OS may terminate the process or take corrective action. In another example, when execution mode is in kernel mode, the OS itself may encounter a page fault while executing kernel-level operations, which are handled by the kernel's memory management routines.

A protection fault may occur when MMU 140 successfully translates the virtual address to a physical address, but the entity generating the virtual address does not have the necessary permissions to perform the requested operation (e.g., read, write, or execute) on the page. The response to a protection fault may depend on the execution mode. For example, when execution mode is in user mode, the OS may trap the fault and terminate the process or send a signal (such as SIGSEGV in Unix-like systems) to the process, allowing it to handle the fault if it has a signal handler. In another example, when execution mode is in kernel mode, a protection fault may indicate a bug or security violation within the kernel itself, prompting the OS to log the fault, invoke debugging routines, or trigger a kernel panic to halt the system for safety. MMU 140 may check the access control bits in the PTE, which may specify the allowed operations for the page, and if the requested operation is not permitted, a protection fault is raised. The fault handling may also involve checking the privilege level of the process, as certain pages may be accessible only in kernel mode, and any access attempt from user mode will result in a protection fault. These mechanisms may provide robust and secure memory management, maintaining system stability and security.

In some instances, MMU 140 may initiate one or more timers (e.g., timer 143) associated with the translation process of translating the virtual address to the physical address.

MMU 140 may schedule delivery of the fault exception based on the type of fault or execution mode. In some instances, the time to detect a protection fault may be shorter than that of a page fault. MMU 140 may delay the generation or delivery of a fault exception associated with a protection fault such that the requesting entity receives a fault exception associated with a protection fault or a fault exception associated with a page fault within a substantially similar time interval between generating the request and receiving the fault exception. By adding a wait time or delay in generating or delivering the fault exception, a malicious user may not be able to extract information from the timing difference between a fault exception of a protection fault and a fault exception of a page fault.

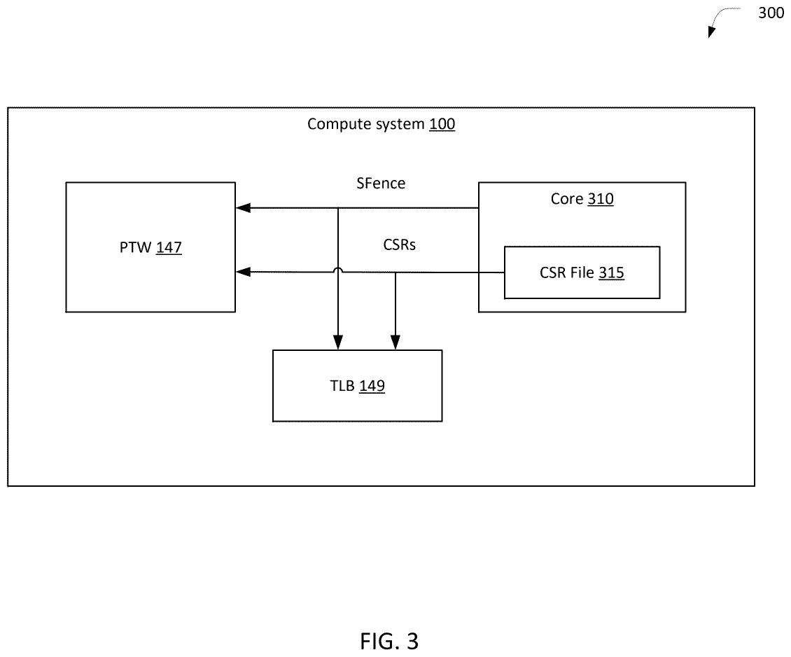

FIG. 3 illustrates a block diagram 300 of aspects of computer system 100. In particular, block diagram 300 illustrates the data paths associated with the translation operation. Computer system 100 may include a core 310. Core 310 may be a processing unit such as a CPU core or a GPU core. Computer system 100 may also include a PTW 147 to perform page table walk searching when the translation is not found in the TLB 149.

Core 310 may include one or more control and status register (CSR) files, e.g., CSR file 315. CSR file 315 may hold control and status information required to manage the operation of core 310. For example, CSR file 315 may be used to configure operational parameters such as execution modes, interrupts, or base address of the page table used for virtual-to-physical address translation. Information such as execution mode or base address of the page table may be provided to PTW 147 or TLB 149.

Core 310 may use store fence (SFence) instruction to enforce ordering constraints on memory operations. SFence may provide that all store operations (e.g., writes) issued before the SFence instruction are completed before any store operations issued after the SFence instruction. SFence is important in multi-core or multi-threaded systems for maintaining memory consistency and controlling the re-ordering of write operations. When the OS or a hypervisor updates the page tables, it may ensure that all previous memory operations are completed before the page tables are modified. The SFence instruction may be provided that all previous store operations are completed before core 310 updates the page tables. After updating the page tables, core 310 may invalidate specific TLB entries to ensure that stable or outdated translations are not used. The SFence instruction may be used with TLB invalidation instruction to maintain memory consistency and correct address translation.

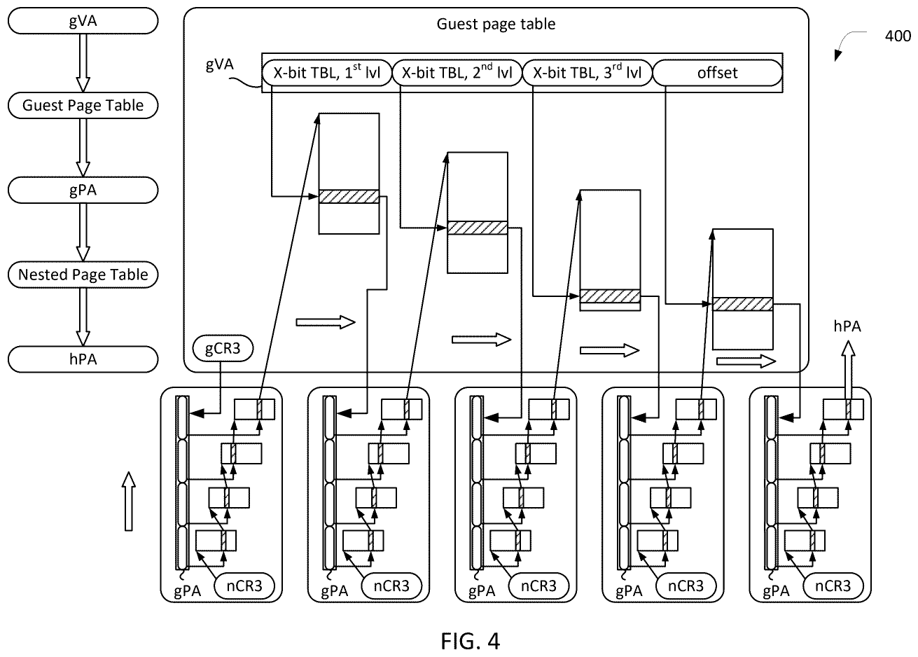

FIG. 4 illustrates another block diagram 400 in accordance with some embodiments. Block diagram 400 illustrates an example of PTE walk of the PTE cache 210 (in FIG. 2). A PTW request may initiate a search of the PTE cache 210.

Compute systems (e.g., compute system 100) may include a host operating system and hypervisor providing virtual machines to guest OS and processes. A guest process may generate access to a virtual address. The virtual address is referred to as a guest virtual address (gVA). The gVA may be translated to a physical memory address in the host, referred to as host physical address (hPA). The translation may be performed in two stages. The first stage may translate gVA or a portion of it to an intermediate address referred to as guest physical address (gPA). In the second stage, the gPA is used in a nested page table walk and may be translated to the hPA. Translation of gVA to gPA may be done using one or more guest page tables.

The guest system may include a control register (gCR), e.g., guest control register 3 (gCR3). The gCR may hold the base address of the page directory in the host. The base address in gCR may be used by MMU 140 to start the translation process of converting the gVA to the hPA. This structure may provide that each virtual machine memory address space is isolated from others, maintaining security and stability.

Similarly, the host system includes a control register associated with the guest, referred to as nested control register (nCR), e.g., nested control register 3 (nCR3). The nCR may hold the base address of the nested page tables used by the hypervisor or the host to translate guest physical address (gPA) to host physical address (hPA).

The PTE walk starts with the base address of the host associated with the gCR. In the first iteration of the first stage, the guest operating system uses gCR to translate the guest virtual address to the guest physical address (gPAs). This may involve walking through the nested page tables starting from the base address stored in nCR.

In the first iteration of the second stage, the gCR may generate a first gPA. The first gPA may include multiple sections. For example, the first Y-bits of the first gPA may be the first level of the gPA, the second Y-bits may be the second level, the third Y-bits may be the third level, and the rest may be the offset. The PTE walk process may start with a host first-page table associated with the nCR and search for the first level of the gPA. A hit of the first level of the gPA may determine the base address of the host second-page table. The PTE walk process may search the host second-page table for the second level of the gPA. A hit of the second level of the gPA may determine the base address of the host third-page table. The PTE walk process may search the host third-page table for the third level of the gPA. A hit of the host third-level of the gPA may determine the base address of the host fourth-page table. The offset of gPA may determine the entity in the host fourth-page table, which in turn determines the base address of the guest first-page table.

The guest virtual address may be divided into several sections. For example, the first X-bits of the guest virtual address may be the first level of the gVA, the second X-bits may be the second level, the third X-bit may be the third level, and the rest may be the offset. In the second iteration of the first stage, the PTE walk procedure may search the guest first-page table for the first level of the gVA. A hist of the first level of the gVA may determine the gPA. The gPA is used for the second iteration of the second stage. The second iteration is similar to the first iteration as described above, using the gPA obtained in the second iteration of the first stage. The process repeats until all the iterations are completed. A host physical address (hPA) may be obtained at the very last iteration.

Any hit in the first stage may cancel the previous-cycle memory read request (s1_kill) and may advance the PTW FSM one level to make a new memory read request using the hit entry content. Any miss at any of the iterations may result in a page fault. In some instances, a system based on a reduced instruction set computer (RISC-V) may include extensions to enhance the capabilities of the PTW for handling address translations. For example, RISC-V architecture may include a supervisor address translation and protection (Svadu) extension providing features for memory management in the operating system and hypervisor. Svadu may provide dual-page table walkers to manage address translations. Svadu may provide nested paging to manage guest-level and host-level address translations, e.g., as described above.

In some embodiments, a fault exception, e.g., a page fault exception, is triggered if a host's physical address is not found. In other embodiments, a host physical address may be associated with the virtual address, e.g., a successful translation of a virtual address to a host address. However, the physical address includes permission that may preclude the requesting entity (e.g., the process that has issued the virtual adders). A fault exception, e.g., a permission fault exception, may be triggered when the requesting entity is not permitted to access the host's physical address. The fault exception may be received by ROB exception monitor 180.

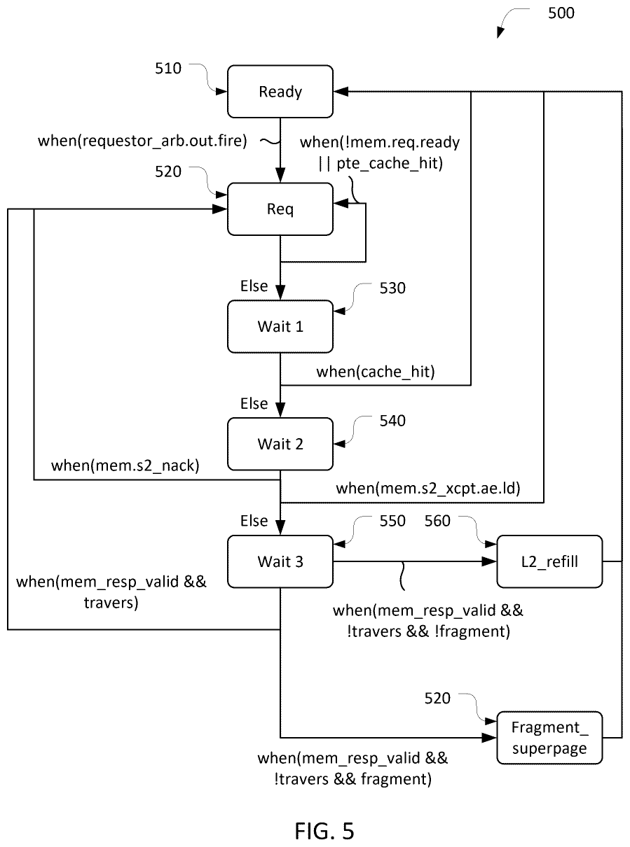

FIG. 5 illustrates a finite state machine 500 of a page table walker in accordance with some embodiments. FSM 500 may be applied in computing system 100, and the MMU 140 in FIG. 1 or 2.

At 510, MMU 140 is ready to receive translation requests. An entity, e.g., a process or program, may generate a virtual address and request MMU 140 to translate the virtual address to a physical address. The entity may be referred to as a requestor.

The FSM 500 may transition from 510 to 520 when the entity (requestor) outputs a request for translating a virtual address, e.g., when(requestor_arb. out. fire). The “arb” in requestor_arb may refer to an arbiter or arbitration logic or module. The arbiter logic may include hardware or software components that manage access to a shared resource by multiple requestors, allowing requests to be handled orderly and fairly. When the fire signal from the requestor arbiter is asserted, the FSM 500 transitions from 510 to 520.

If the translation is available in the PTE cache (e.g., PTE cache 210 in FIG. 2) or the memory module is not ready to accept a new request the FSM 500 may transition back to 510. Otherwise, the FSM 500 may transition to 530, when the memory is ready to receive an access request and a TBL miss is detected. At 530, a first wait time is applied before proceeding to the next state.

FSM 500 may transition from 530 to 510 when the translation is available in the L2 cache (e.g., L2 TLB in FIG. 2) and a L2 cache hit is detected. Otherwise, FSM 500 may transition to 540 where additional wait time is applied before proceeding to the next state.

FSM 500 may transition from 540 to 510 when a fault exception, e.g., access error or address error exception identifier, is detected. However, in case of a negative acknowledgment (NACK) indicating that a translation was not found or an error is detected, FSM 500 may transition from 540 to 520. Otherwise, FSM 500 may transition from 540 to 550, where additional wait time is applied before proceeding to the next state.

FSM 500 may transition from 550 to 560 when the translation to the physical address is successful, the physical address is a valid memory address, and no traversal or fragmentation operations are ongoing. Traversal operation may be an example of page table walk operation. At 560, the translation may be added to the TBL, and FSM 500 may transition from 560 to 510, waiting to receive another request.

FSM 500 may transition from 550 to 570 when the translation to the physical address is successful; the physical address is a valid memory address, no traversal operation is ongoing, and fragmentation operation is ongoing. FSM 500 may perform a fragmentation operation of the super page at 570 and then transition to 510.

FSM 500 may transition from 550 to 520 when the walk through the page table is successful, but the walk is not complete, and transverse operation through the remaining page tables is ongoing.

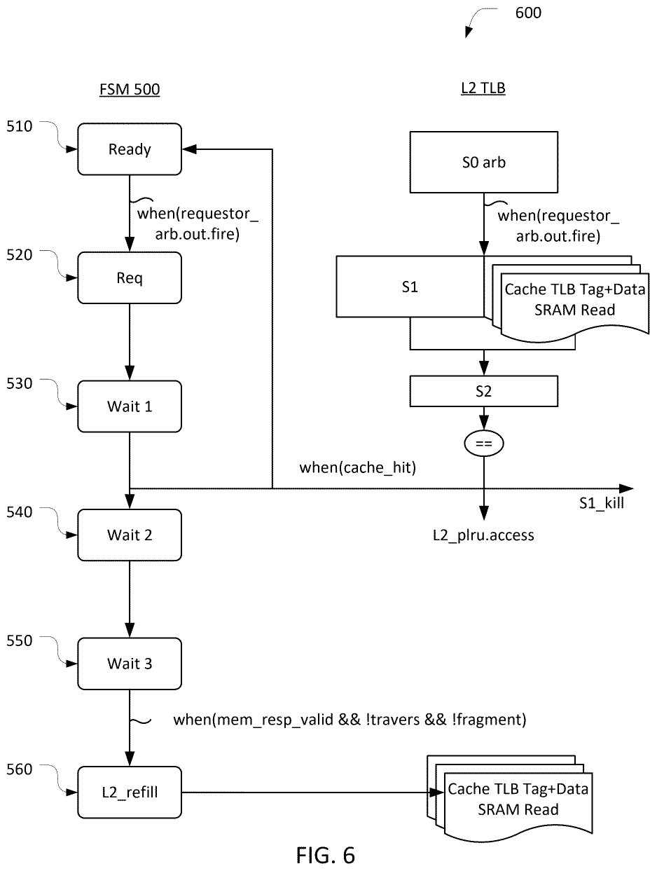

FIG. 6 illustrates a finite state machine 600 of a unified translation look-aside buffer operation in accordance with some embodiments. FSM 600 may be applied in MMU 140 in FIG. 1 or 2. The FSM 500 is the same as FSM 500 and states 510-560 are the same as those described above. FSM 600 is an example of FSM 500 along with the L2 TLB check, e.g., for a system block diagram of FIG. 1 or 2.

At S1, a request for translation of a virtual address to a physical address is received. MMU 140, may identify the cache TLBs.

At S2, MMU 140 may look up the cache TLB for a translation of the virtual memory. In case of a cache hit, the S1 is terminated. MMU 140 may update the L2 TLB. For example, the pseudo-least recently used (PLRU) cache replacement policy may be applied. When the L2 cache is accessed, the PLRU algorithm may update the status of the cache lines.

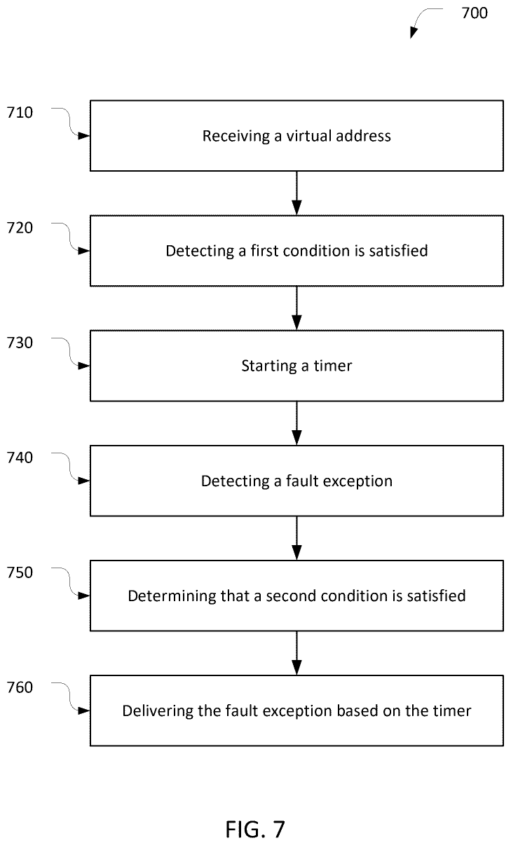

FIG. 7 illustrates a flow diagram in accordance with some embodiments. The flow diagram 700 may be performed or implemented by a compute system such as, for example, the compute system 100, multi-chip package 800, or system 900; or components thereof, for example, CPU 840, GPU 850, or processors 910.

The flow diagram 700 may include, at 710, receiving a virtual address. A process or a program (requestor) may generate a virtual memory address. MMU 140 may receive the virtual address and translate it into a physical address.

The requesting process or program may be associated with an execution mode. For example, the requesting process or program may be in user-mode or kernel-mode. In some examples, user-mode is a restricted execution mode for running application software and non-privileged processes. Processes in user-mode may have limited access to system resources and hardware. They may only interact with hardware and perform certain system-level tasks through interfaces provided by the operating system. User-mode processes may be restricted to access only their allocated memory regions. Attempts to access memory regions outside their scope (e.g., kernel memory) may result in a protection or access permission fault. kernel-mode is a privileged execution mode for running the operating system kernel and other low-level system software. In kernel-mode, the operating system may have full access to all system resources, including hardware devices, memory, and the processing unit. Processes running in kernel-mode may have access to all memory addresses, including those reserved for the operating system and hardware. Kernel-mode may be used for executing system tasks such as managing hardware, handling interrupts, executing low-level device drivers, or performing system calls on behalf of user-mode processes. One or more bits or flags in a register may indicate the execution mode of a process. For example, a special register such as the processor status register (PSR), program status word (PSW), or control register (CR) may contain flags that indicate the current state of the processor, including the execution mode. One or more bits in the PSR, PSW, or CR may indicate whether the processing unit is operating in user-mode or kernel-mode. For example, a value of ‘0’ of the mode bit may indicate user-mode, and a value of ‘1’ of the mode bit may indicate kernel-mode.

In some embodiments, the page table entry associated with the virtual-to-physical translation may include a user bit. If the user bit is set, e.g., user bit has a value of ‘1’, the physical address is associated with a kernel-mode and a user bit that is cleared, e.g., user bit has a value of ‘0’, may indicate that the physical address is associated with a user-mode.

The flow diagram 700 may include, at 720, detecting a first condition. The first condition may be associated with a search of the virtual address in a TLB. Detecting the first condition may include detecting a TLB hit or a TLB miss. The TLB may be an L1 TLB (e.g., L1 ITLB or L1 DTLB) or an L2 TLB.

The flow diagram 700 may include, at 730, starting a timer. MMU 140 may start the timer. MMU 140 may start the timer based on detecting the first condition. For example, MMU 140 may start the timer upon detecting a TLB hit or a TLB miss. In some embodiments, MMU 140 may start the timer only when a TLB miss is detected. In other embodiments, MMU 140 may start the timer only when a TLB hit is detected.

The value of the timer, T1, may be programmable. For example, the host OS may set the value of the timer. The timer may be implemented as a countdown that starts from a value and counts down and will expire when the timer reaches the value of zero. In some implementations, the timer may start from a value T0, e.g., zero, and increment until it reaches T0+T1. The timer may count wall-clock elapsed time by comparing it with the GHRT. Alternatively, the timer may be implemented using a cycle counter.

The value of the timer may be stored in a register, e.g., a control and state register (CSR), In some embodiments, the kernel may add a random value to the value of the timer. The random value may be positive or negative. In some implementations, the random value may always be positive, only increasing the timer duration. Whether to add random value to the timer value may also be programmable. For example, a flag may indicate whether adding a random value to the timer value is enabled.

The flow diagram 700 may include, at 740, detecting a fault exception. The fault exception may be associated with the translation operation of the virtual address to a physical address. In some embodiments, the fault exception is associated with access permission. The access permission exception is generated when the process attempts to access a memory region without the necessary permission. The process in user-mode may generate a virtual memory address that translates to a physical memory address that is restricted to the process. For example, the translated physical address may be in a region dedicated to kernel restricted to the user-mode process.

In some embodiments, the fault exception is associated with a page fault. The page fault exception is generated when the virtual address cannot be translated to a physical address. In some examples, page fault exceptions may be generated when the translation does not exist, e.g., the virtual address cannot be mapped to a physical address. In some examples, the page fault exception may be generated when the translation exists, e.g., the virtual address is mapped to a physical address; however, the physical address may be invalid. In some cases, the time between generating a request for translation of a virtual address and the generation of page fault exception is longer than the time between generating a request for translation of a virtual address and the generation of a protection or access permission fault.

In some embodiments, the value of the timer may depend on the execution mode. In some embodiments, the value of the timer may depend on whether a TLB hit or a TLB miss is detected. In some other embodiments, the value of the timer may depend on whether the fault exception is a protection fault exception or a page fault exception.

The flow diagram 700 may include, at 750, determining that a second condition is satisfied. The second condition may be associated with the execution mode. Determining that the second condition is satisfied may include determining that the execution mode is set to a first mode, e.g., user-mode, and determining that the fault exception is based on an invalid page table entry or invalid permission.

An invalid PTE may indicate that the corresponding virtual memory address does not have a valid mapping to a physical memory address and the virtual address cannot be translated into a physical address. An invalid PTE may result in a page fault exception.

In some embodiment, when a physical address translation is found, the corresponding PTE may include user bit. The value of the user bit may indicate whether the corresponding memory region is accessible by a user. For example, a user bit set, e.g., having a value of ‘1’ may indicate that the physical memory address is accessible by the user (and kernel). The user bit having a value of ‘0’ may indicate that the physical memory address is accessible by the kernel only.

The flow diagram 700 may include, at 760, delivering the fault exception. ROB exception monitor 180 may receive the fault exception. ROB exception monitor 180 may deliver or execute the fault exception when the timer expires. In some instances, the ROB exception monitor may deliver or initiate execution of the fault exception upon expiration of the timer, even when the fault exception is not the oldest in the ROB exception monitor.

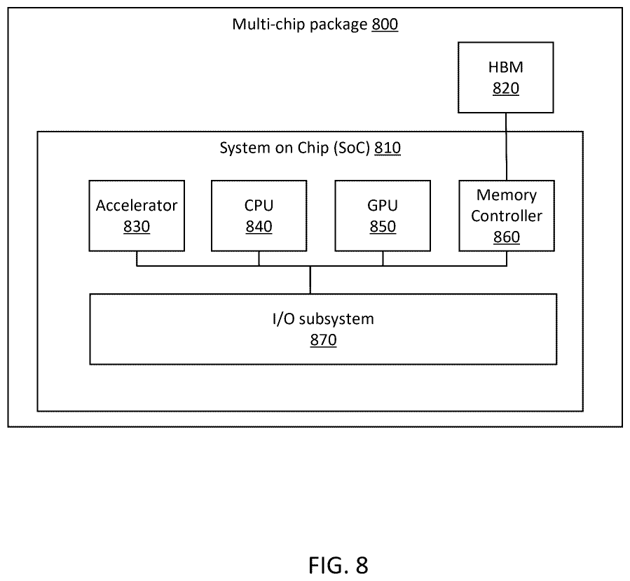

FIG. 8 is a diagram of an embodiment of a multi-chip package (MCP) 800 in accordance with some embodiments. MCP 800 can correspond to a computing device including, but not limited to, a server, a workstation computer, a desktop computer, a laptop computer, a hand-held device such as a smartphone, or a tablet computer. MCP may include packaging multiple integrated circuits (ICs) within a single package. MCP 800 may include a system-on-chip (SoC) 810 and a high-bandwidth memory (HBM) stack 820.

HBM 820 may provide high bandwidth throughput and low power consumption. HBM 820 may employ a large number of data channels to transfer data simultaneously. HBM 820 may stack multiple memory dies vertically, connected by through-silicon vias (TSVs), allowing for a greater density of memory cells and efficient use of space. The three-dimensional (3D) stacking increases the memory capacity and data transfer rates between the memory layer and the processors within the MCP 800.

SoC 810 can integrate components of a computing system into a single chip. SoC 810 may include one or more of an accelerator 830, at least one Central Processing Unit (CPU) 840, a Graphics Processor Unit (GPU) 850, a memory controller 860, or an input/output (I/O) system 870. Components of SoC 810 may be communicatively coupled with one another or other components of the MCP 800.

Accelerator 830 can include hardware or software components designed to perform specific computational tasks more efficiently than a general processor such as CPU 830. Accelerator 830 may offload and expedite particular functions from being executed by CPU 840. Digital signal processors (DSPs) for audio and communication signal processing or neural network accelerators for artificial intelligence and machine learning workloads are instances of accelerators 830.

CPU 840 is an example of a general-purpose CPU designed to perform fundamental functions such as executing arithmetic, logic, control, or input/output operations. CPU 840 may operate in conjunction with other components such as GPU 850, accelerator 820, memory controller 860, or I/O system 870.

CPU 840 may correspond to a single-core or a multi-core general-purpose processor. In one example, CPU 840 can include multiple cores, where each core includes one or more instruction and data caches, execution units, prefetch buffers, instruction queues, branch address calculation units, instruction decoders, or floating point units.

GPU 850 may be a specialized processor for handling tasks related to rendering and processing images or videos. GPU 850 can include one or more GPU cores. In one example, GPU cores may include one or more execution units and one or more instruction and data caches.

SoC 810 can also include one or more memory controllers 860. The memory controller 860 is communicatively coupled with memory and other components of the SoC 810, such as CPU 830, GPU 840, or the accelerator 850. Memory controller 860 can include circuitry for accessing and controlling memory devices, such as memory dies, in the HBM stacks 820.

SoC 810 can include a memory controller 860. Memory controller 860 is communicatively coupled with memory and other components of the MCP 800, such as accelerator 830, CPU 840, or GPU 850. The memory controller includes circuitry for accessing and controlling memory devices, such as memory dies in HBM stacks 820. Memory controller 860 may be responsible for managing the flow of data between MCP 800 and the memory. The flow of data may include reading and writing of data by the MCP 800 to and from the memory.

The I/O subsystem 870 may include one or more I/O adapters to translate a host communication protocol utilized within the processor core(s) to a protocol compatible with particular I/O devices. Examples of protocols include Peripheral Component Interconnect (PCI)-Express (PCIe), Universal Serial Bus (USB), Serial Advanced Technology Attachment (SATA), and Institute of Electrical and Electronics Engineers (IEEE) 1594 “Firewire.”

In one example, the I/O subsystem 870 can communicate with external I/O devices, which can include, for example, user interface device(s) including a display or a touch-screen display, printer, keypad, keyboard, communication logic, wired or wireless, storage device(s) including hard disk drives (“HDD”), solid-state drives (“SSD”), removable storage media, Digital Video Disk (DVD) drive, Compact Disk (CD) drive, Redundant Array of Independent Disks (RAID), tape drive or other storage device.

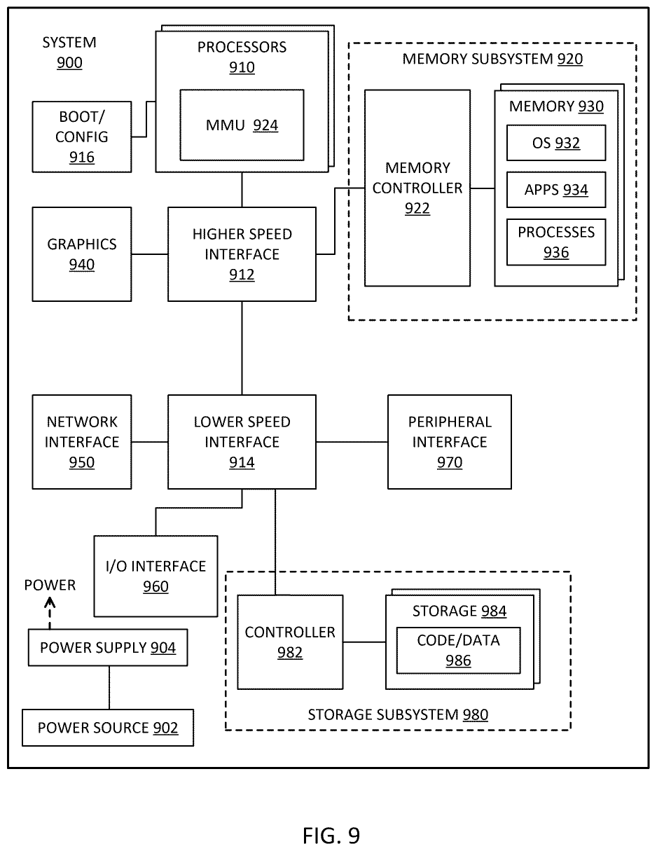

FIG. 9 is a block diagram of an example of a computing system in accordance with some embodiments. System 900 represents a computing device in accordance with any example herein and can be a laptop computer, a desktop computer, a tablet computer, a server, a gaming or entertainment control system, an embedded computing device, or other electronic devices.

In one example, system 900 includes MMU 924. MMU 924 is an example of MMU 14 implementing aspects of the embodiments described above, including utilizing a timer to make fault exceptions of unused or unmapped pages (e.g., page fault exceptions) to have the same timing as fault exceptions of access permission violation.

System 900 includes processor 910. Processor 910 can include any type of microprocessor, central processing unit (CPU), graphics processing unit (GPU), processing core, or other processing hardware, or a combination, to provide processing or execution of instructions for system 900. Processor 910 can be a host processor device. Processor 910 controls the overall operation of system 900 and can be or include one or more programmable general-purpose or special-purpose microprocessors, digital signal processors (DSPs), programmable controllers, application-specific integrated circuits (ASICs), programmable logic devices (PLDs), or a combination of such devices. Processor 910 may be an example of MCH 8000 in FIG. 8.

System 900 includes boot/config 916, which represents storage to store boot code (e.g., basic input/output system (BIOS)), configuration settings, security hardware (e.g., trusted platform module (TPM)), or other system-level hardware that operates outside of a host OS (operating system). Boot/config 916 can include a non-volatile storage device, such as read-only memory (ROM), flash memory, or other memory devices.

In one example, system 900 includes interface 912 coupled to processor 910, which can represent a higher speed interface or a high throughput interface for system components that need higher bandwidth connections, such as memory subsystem 920 or graphics interface components 940. Interface 912 represents an interface circuit, which can be a stand-alone component or integrated into a processor die. Interface 912 can be integrated as a circuit onto the processor die or integrated as a component on a system on a chip. Where present, the graphics interface 940 interfaces to graphics components to provide a visual display to a user of system 900. Graphics interface 940 can be a stand-alone component or integrated onto the processor die or system on a chip. In one example, the graphics interface 940 can drive a high-definition (HD) display or ultra-high definition (UHD) display that provides an output to a user. In one example, the display can include a touch-screen display. In one example, the graphics interface 940 generates a display based on data stored in memory 930 or based on operations executed by processor 910 or both.

Memory subsystem 920 represents the main memory of system 900 and provides storage for code to be executed by processor 910 or data values to be used in executing a routine. Memory subsystem 920 can include one or more varieties of random-access memory (RAM), such as DRAM, 3DXP (three-dimensional crosspoint), or other memory devices, or a combination of such devices. Memory 930 stores and hosts, among other things, operating system (OS) 932 to provide a software platform for executing instructions in system 900.

Additionally, applications 934 can execute on the software platform of OS 932 from memory 930. Applications 934 represent programs with their own operational logic to execute one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller that generates and issues commands to memory 930. It will be understood that the memory controller 922 could be a physical part of processor 910 or a physical part of interface 912. For example, memory controller 922 can be an integrated memory controller integrated onto a circuit with processor 910, such as integrated onto the processor die or a system on a chip.

While not explicitly illustrated, it will be understood that system 900 can include one or more buses or bus systems between devices, such as a memory bus, a graphics bus, interface buses, or others. Buses or other signal lines can communicatively or electrically couple components together or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other buses, or a combination.

In one example, system 900 includes interface 914, which can be coupled to interface 912. Interface 914 can be a lower-speed interface than interface 912. In one example, interface 914 represents an interface circuit, which can include stand-alone components and integrated circuitry. In one example, multiple user interface components, peripheral components, or both are coupled to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can exchange data with a remote device, which can include sending data stored in memory or receiving data stored in memory.

In one example, system 900 includes one or more input/output (I/O) interface(s) 960. I/O interface 960 can include one or more interface components through which a user interacts with system 900 (e.g., audio, alphanumeric, tactile/touch, or other interfacings).

Peripheral interface 970 can include any hardware interface not specifically mentioned above.

Peripherals generally refer to devices that connect dependently to system 900. A dependent connection is one where system 900 provides the software platform or hardware platform or both on which operation executes and with which a user interacts.

In one example, system 900 includes storage subsystem 980 to store data in a non-volatile manner. In one example, in certain system implementations, at least certain components of storage 980 can overlap with components of memory subsystem 920. Storage subsystem 980 includes a storage device(s) 984, which can be or include any conventional medium for storing large amounts of data in a non-volatile manner, such as one or more magnetic, solid state, NAND, 3DXP, or optical-based disks, or a combination. Storage 984 holds code or instructions and data 986 in a persistent state (i.e., the value is retained despite interruption of power to system 900). Storage 984 can be generically considered to be “memory,” although memory 930 is typically the executing or operating memory to provide instructions to processor 910. Whereas storage 984 is non-volatile, memory 930 can include volatile memory (i.e., the value or state of the data is indeterminate if power is interrupted to system 900). In one example, storage subsystem 980 includes controller 982 to interface with storage 984. In one example, controller 982 is a physical part of interface 914 or processor 910 or can include circuits or logic in both processor 910 and interface 914.

Power source 902 provides power to the components of system 900. More specifically, power source 902 typically interfaces to one or multiple power supplies 904 in system 900 to provide power to the components of system 900. In one example, power supply 904 includes an AC to DC (alternating current to direct current) adapter to plug into a wall outlet. Such AC power can be renewable energy (e.g., solar power) power source 902. In one example, power source 902 includes a DC power source, such as an external AC to DC converter. In one example, power source 902 or power supply 904 includes wireless charging hardware to charge via proximity to a charging field. In one example, power source 902 can include an internal battery or fuel cell source.

### EXAMPLES

In the following sections, further exemplary embodiments are provided.

Example 1 includes a method including: receiving a virtual address associated with an execution mode; detecting a first condition associated with a search of the virtual address in a translation lookaside buffer (TLB); starting a timer based on said detecting the first condition; detecting a fault exception associated with a translation operation of the virtual address; determining that a second condition is satisfied, wherein the second condition is associated with the execution mode; and delivering the fault exception based on the timer.

Example 2 includes the method of example 1 or some other examples herein, wherein the detecting a first condition associated with a search of the virtual address in a TLB includes: detecting a TLB miss; or detecting a TLB hit.

Example 3 includes the method of examples 1 or 2 or some other examples herein, wherein a value of the timer is programmable.

Example 4 includes the method of any of examples 1-3 or some other examples herein, wherein a value of the timer is contained in a register.

Example 5 includes the method of any of examples 1-4 or some other examples herein, the method further includes: determining that adding a random value to a value of the timer is allowed.

Example 6 includes the method of any of examples 1-5 or some other examples herein, the method further includes adding the random value to the value of the timer.

Example 7 includes the method of any of examples 1-6 or some other examples herein, wherein the timer is based on a global high-resolution timer or a cycle counter.

Another example may include an apparatus comprising means to perform one or more elements of a method described in or related to any of examples 1-7 or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-7, or any other method or process described herein.

Another example may include an integrated circuit, a computer system, or an apparatus comprising logic, modules, or circuitry to perform one or more elements of a method described in or related to any of examples 1-7 or any other method or process described herein. Logic or modules may include hardware or software components.

Another example may include a method, technique, or process as described in or related to any of examples 1-7, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-7, or portions thereof.

Another example may include a signal as described in or related to any of examples 1-7, or portions or parts thereof.

Another example may include a datagram, information element, packet, frame, segment, or message as described in or related to any of examples 1-7, or portions or parts thereof, or otherwise described in the present disclosure.

Another example may include a signal encoded with data as described in or related to any of examples 1-7, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-7, or portions thereof.

Another example may include a computer program comprising instructions, wherein execution of the program by a processing element is to cause the processing element to carry out the method, techniques, or process as described in or related to any of examples 1-7, or portions thereof.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. A method comprising:
receiving a virtual address associated with an execution mode;
detecting a first condition associated with a search of the virtual address in a translation lookaside buffer (TLB);
starting a timer based on said detecting the first condition;
detecting a fault exception associated with a translation operation of the virtual address;
determining that a second condition is satisfied, wherein the second condition is associated with the execution mode; and
delivering the fault exception upon expiration of the timer to delay delivery of the fault exception.

2. The method of claim 1, wherein said detecting the first condition comprises:
detecting a TLB miss; or
detecting a TLB hit.

3. The method of claim 1, wherein a value of the timer is programmable.

4. The method of claim 1, wherein a value of the timer is contained in a register.

5. The method of claim 1, wherein the timer is based on a global high-resolution timer or a cycle counter.

6. The method of claim 1, further comprising:
determining that adding a random value to a value of the timer is allowed.

7. The method of claim 6, further comprising:
adding the random value to the value of the timer.

8. An integrated circuit comprising:
a memory management unit;
a timer; and
processing circuitry coupled with the memory management unit and the timer to:
receive a virtual address associated with an execution mode;
detect a first condition associated with a search of the virtual address in a translation lookaside buffer (TLB);
start a timer based on the detection of the first condition;
detect a fault exception associated with a translation operation of the virtual address;
determine that a second condition is satisfied, wherein the second condition is associated with the execution mode; and
deliver the fault exception upon expiration of the timer to delay delivery of the fault exception.

9. The integrated circuit of claim 8, wherein to detect the first condition the processing circuitry is to:
detect a TLB miss; or
detect a TLB hit.

10. The integrated circuit of claim 8, wherein a value of the timer is programmable.

11. The integrated circuit of claim 8, wherein a value of the timer is stored in a register.

12. The integrated circuit of claim 8, wherein the timer is based on a global high-resolution timer or a cycle counter.

13. The integrated circuit of claim 8, further comprising:
determining that adding a random value to a value of the timer is allowed.

14. The integrated circuit of claim 13, further comprising:
adding the random value to the value of the timer.

15. A computer system comprising:
memory to store computer-executable instructions; and
an integrated circuit to access the memory and execute the computer-executable instructions to:
receive a virtual address associated with an execution mode;
detect a first condition associated with a search of the virtual address in a translation lookaside buffer (TLB);
start a timer based on the detection of the first condition;
detect a fault exception associated with a translation operation of the virtual address;
determine that a second condition is satisfied, wherein the second condition is associated with the execution mode; and
deliver the fault exception upon expiration of the timer to delay delivery of the fault exception.

16. The computer system of claim 15, wherein to detect the first condition the integrated circuit is to:
detect a TLB miss; or
detect a TLB hit.

17. The computer system of claim 15, wherein a value of the timer is programmable.

18. The computer system of claim 15, wherein a value of the timer is stored in a register.

19. The computer system of claim 15, further comprising:
determining that adding a random value to a value of the timer is allowed; and
adding the random value to the value of the timer.

20. The computer system of claim 15, wherein the timer is based on a global high-resolution timer or a cycle counter.
